(19) United States
(12) Patent Application Publication
(10) Pub. No.: US 2019/0226632 A1
(43) Pub. Date: Jul. 25, 2019

(54) Support stand

(71) Applicant: Peter Dwight Orgias, Brooklyn, NY (US)

(72) Inventor: Peter Dwight Orgias, Brooklyn, NY (US)

(21) Appl. No.: 15/932,006

(22) Filed: Jan. 23, 2018

(51) Int. Cl. F16M 11/24; F16M 11/04; B44B 1/06

(52) U.S. Cl. CPC F16M 11/24; F16M 11/041; B44B 1/06; B44B 2700/12; F16M 2200/04; F16M 2200/08; F16M 2200/024

(57) ABSTRACT

Abstract: is a support stand with and extension comprising support tray, (1) base stand, (2) upper extension attachment, (3) base stand stabilizer, (7) top extension arm, (8) height extension attachment, (14) uni arm stabilizer, (18) extension piece, (22) base stabilizer, (30) loose tray unit arm, (35) base stabilizer, (36) whole long arm uni extension (36). Hereby referred to as “unit”

### BACKGROUND-FIELD OF INVENTION

This invention relates to support stands, specifically to such paste and hawks which are used for extension in sculpture, art, construction use ect.

### BACKGROUND-DESCRIPTION OF PRIOR ART

Carpenters and other users alike commonly used hawks and pasting trays for many various construction projects requiring some form of pasting etc.

Originally the user will just place the paste etc., on the hawk when they are ready to use it, now the user can place the paste on the hawk and leave it standing until the user is ready to use. The user will usually waste allot of material and money by spills. When individuals are using compound taping sheetrock, etc., they have to bend down consistently a lot to add more material causing back pain etc.

Thus a carpenter etc., cannot reach high or low places and could not can put his pasting hawk down for periods of time without losing any material. The current hawks do not stand upright alone and does not allow for an extension for higher places.

### OBJECTS AND ADVANTAGES

Accordingly, besides the objects and advantages of the cover described in my above patent, several objects and advantages of the present invention are:
(a) to provide a stand which can be produced in a variety of colors;
(b) to provide stand whose production allows for a convenient and extremely rapid;
(a) to provide a stand which the user can get to high places;
(b) to provide the user less bending;

Further objects and advantages are to provide a stand which can be used easily and conveniently to allow for an extension, which the user can work in high or low places, which gives the user the ability to get more work done with less back pain etc., which can allow for the user to get work done faster which and keep the use form wasting materials due to spills, which allows the hawk to remain upright when not in use. Still further objects and advantages will become apparent from a consideration of the ensuing description and drawings.

FIG. 1 is a support stand with and extension comprising 1 support tray, 2 base stand, 3 upper extension attachment, 7 base stand stabilizer, 8 top extension arm, 14 height extension attachment, 18 uni arm stabilizer, 22 extension piece, 30 base stabilizer, 35 loose tray unit arm, 30 base stabilizer, 36 whole long arm uni extension. Hereby referred to as “unit”

Reference Numerals In Drawings

| | | | |
|---|---|---|---|
| 1 | support tray | 18 | uni arm stabilizer |
| 2 | base stand | 22 | extension piece |
| 3 | upper extension attachment | 30 | base stabilizer |
| 7 | base stand stabilizer | 35 | loose tray unit arm |
| 8 | top extension arm | 30 | base stabilizer |
| 36 | whole long arm uni extension | | |

Description—FIGS. 1 to 9

A typical embodiment of the support tray 1 of the present invention in combination having a base stand 2, 30 has a core which the support tray 1 rests in whereby the hawk rests within the top of the top extension 8 and the top extension 8 fits within the top extension attachment 3 the hawk then can be extended for usage on high areas like ceilings and walls etc., with the extension attachment 3, 14, whereby thus the user can now free up their hands to do another task until ready to use the hawk and pasting tray. The extension attachment 3 in combination extends and locks in place with the extra extension 22 for stability. A thumb slot 5 is located on the side of the housing stand arm top extension 8 and the extension attachment 3 also has a slot 10 for quick release from hawk from the top extension 8 whereby the user will not have to bend down as much stopping back pain and injuries, the user will no longer have to lose his material by laying his hawk and pasting tray down and it lying on its side causing a messy cleanup and wasted materials. Top extension arm 8 in combination fits in base stand stabilizer core 6 the hawk and pasting tray also can rest within upper extension attachment core 29 or within the top extension arm 8 the hawk and pasting tray can rest within the base stand stabilizer core 6 whereby the upper extension attachment thumb slot 5 will allow the hawk to be easily removed for use and the hawk can be used while within the top extension arm 8 until needed to stand alone with base stand stabilizer 7.

Height extension attachment 14 may use the twist lock 19, 20, 24 with the lock slots 26, 27, 28 to lengthen with the extension piece 22. The height extension attachment 14 may vary in its mode of attachment as to achieve said function.

The paste tray and hawks' arm rests within the top extension 8 the extension attachment 3, 14, 22 can be extended and twist locked 19, 20, 24 due to small slots 26, 27, 28 placed on the top of the extension pieces 3, 14, 22, 23. The extension 3, 14, 22, 23 in combination having the support stand may be modified for adjustable height with the height extension 3, 14 and may not be used if the user does not require_height, the height extension 3, 14, can be extended individually whereby as to get the approximate height required. The paste tray base stabilizer 2, 30 can be used alone with the hawk, paste tray top extension 8 and may rest alone within the extension stabilizer core 6 as needed. The said unit may not be limited to the attachment piece extensions 3, 14, 22, 23 being able to extend by other such approximate means as electrical, hydraulics, etc. The holes 39 allow for the base stand 2 to stabilize on various surfaces like soil, mulch, sand etc.

### Summary, Ramifications, and Scope

Accordingly, the reader will see that the hawk stand of this invention can be removable.

The support stand has additional advantages in that
My support stand thus;
the size of the housing of the support stand may be larger or smaller;
the color of the housing of the support stand may vary;
the shape of the housing of the support stand may vary;
height extension attachment 14 may vary in its mode of attachment;
the extentions may vary in its length and thickness;
the material of the of the housing of the support stand may vary;
the housing of the support stand may be one piece or separate sections;
the extension may automatically extend due to pneumatics, air pressure and other various forms of mechanization.
The base 3 may secure to the surface via suction;
The base 3 may also secure to soil like surfaces via hooks, spikes etc., via holes 39.
Thus the scope of the invention should be determined by the appended claims and their legal equivalents, rather than by the examples given.

I, Peter Orgias, have invented a new design for a support stand, as set forth in the following specification. The support stand allows you to rest your paste tray, hawk when you are working and also allows you to extend your hawk when working in high places.

FIG. 1 is a front view perspective of the support stand according to the present invention.

FIG. 2 is an exploded view of the top extension 8 with the base stabilizer 7 of FIG. 1.

FIG. 3 is a front exploded view of the paste tray base stabilizer 7 with the removable hawk top extension 8, height extension attachment 14.

FIG. 4 is a front view of the paste tray base stabilizer 7 the extension attachment 3 with the removable height extension attachment 14.

FIG. 5 is an exploded front view of the top extension 8, paste tray base stabilizer core 6 the top extension attachment 3 with the removable height extension stabilizer 14, 22.

FIG. 6 is a front view of base stabilizer 7, loose tray unit arm 35, whole long arm uni extension 36.

FIG. 7 is an exploded view of showing the extension attachment 3, base stabilizer 7, top extension 8, extension attachment 14, extra extension 22, loose tray unit arm 35.

FIG. 8 is a front view of base stand 2, 30, base stabilizer 7, loose tray unit arm 35.

FIG. 9 is an exploded view of the loose tray unit arm 35 and the base stand 2.

I claim the design for a support stand as shown and described.

### BRIEF DESCRIPTION OF THE DRAWINGS

FIG. 1 is a front view perspective of the hawk tray stand according to the present invention.

FIG. 2 is an exploded view of the top extension 8 with the base stabilizer 7 of FIG. 1.

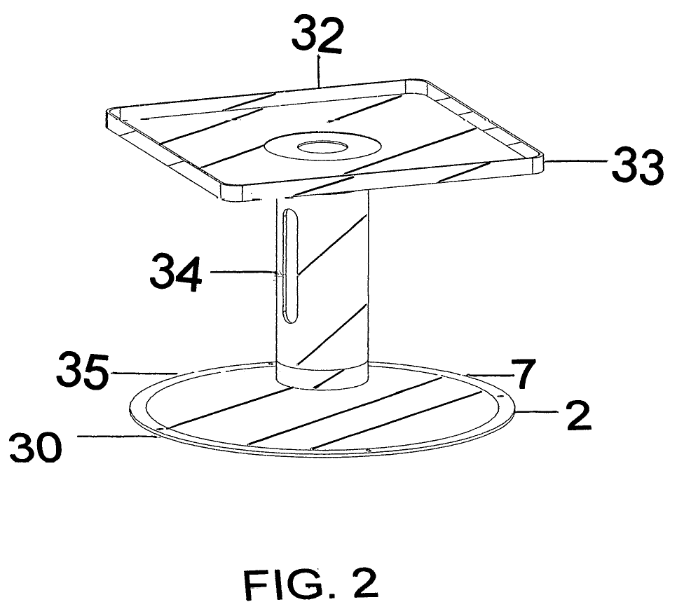

FIG. 3 is a front exploded view of the paste tray base stabilizer 7 with the removable hawk top extension 8, height extension attachment 14.

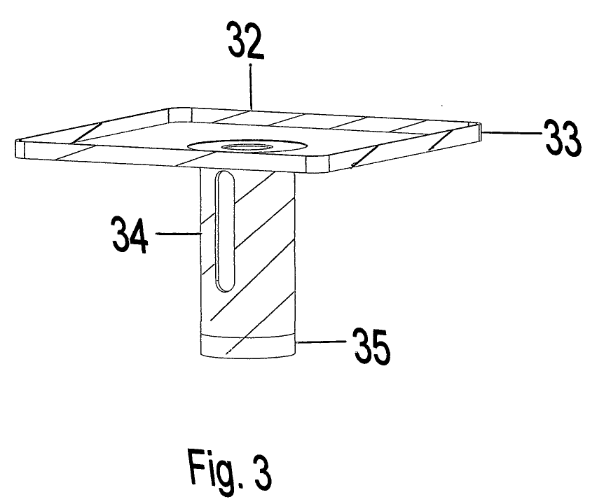

FIG. 4 is a front view of the paste tray base stabilizer 7 the extension attachment 3 with the removable height extension attachment 14.

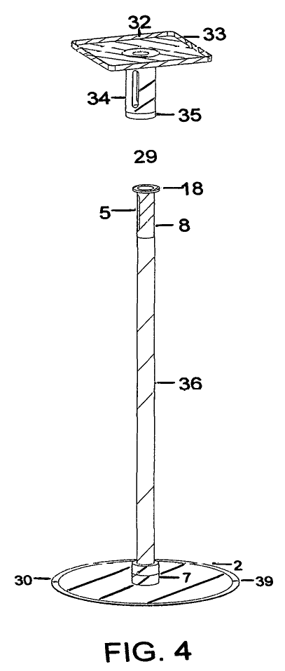

FIG. 5 is an exploded front view of the top extension 8, paste tray base stabilizer core 6 the top extension attachment 3 with the removable height extension stabilizer 14, 22.

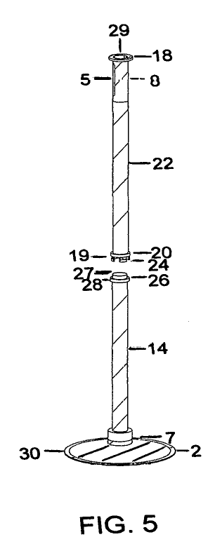

FIG. 6 is front view of base stabilizer 7, loose tray unit arm 35, whole long arm uni extension 36.

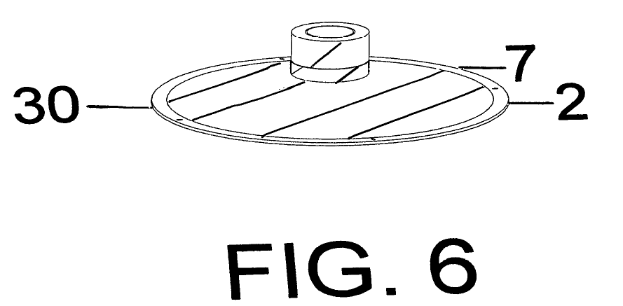

FIG. 7 is an exploded view of showing the extension attachment 3, base stabilizer 7, top extension 8, extension attachment 14, extra extension 22, loose tray unit arm 35.

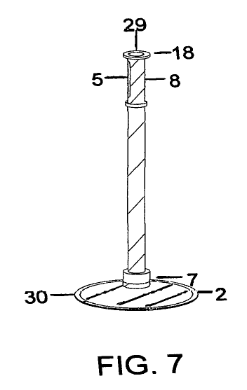

FIG. 8 is a front view of base stand 2, 30, base stabilizer 7, loose tray unit arm 35.

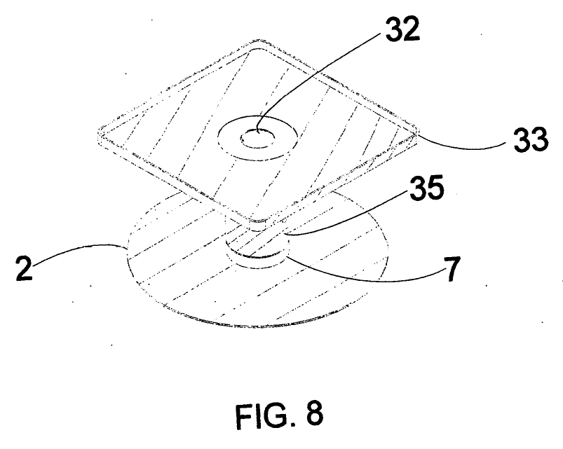

FIG. 9 is an exploded view of the base stand 2, 30, base stabilizer 7 with the loose tray unit arm 35.

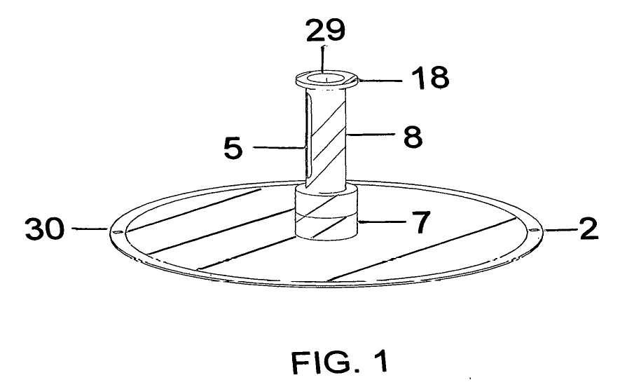

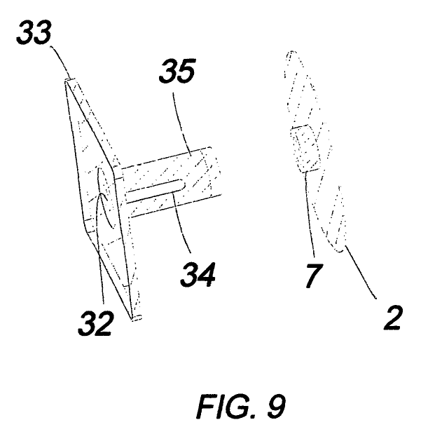

FIG. 1 is a support stand with and extension comprising 1 support tray, 2 base stand, 3 upper extension attachment, 7 base stand stabilizer, 8 top extension arm, 14 height extension attachment, 18 uni arm stabilizer, 22 extension piece, 30 base stabilizer, 35 loose tray unit arm, 30 base stabilizer, 36 whole long arm uni extension. Hereby referred to as “unit”
1. A support stand of claim 1 wherein a hawk whereby which allows the pasting trays, hawks etc., to stand upright freely and extend height.
2. The support tray 1 of claim 1 wherein having a base stand 2, 30 has a core which the support tray 1 rests in whereby the hawk rests within the top of the top extension 8 and the top extension 8 fits within the top extension attachment 3 the hawk then can be extended for usage on high areas like ceilings and walls etc., with the extension attachment 3, 14, whereby thus the user can now free up their hands to do another task until ready to use the hawk and pasting tray.
3. The extension attachment 3 of claim 1 wherein by means of extends and may lock in place with the extra extension 22 for stability. A thumb slot 5 of claim 1 wherein is located on the side of the housing stand arm top extension 8 and the extension attachment 3 also has a slot 10 for quick release from hawk from the top extension 8 whereby the user will not have to bend down as much stopping back pain and injuries, the user will no longer have to lose his material by laying his hawk and pasting tray down and it lying on its side causing a messy cleanup and wasted materials.
4. Top extension arm 8 of claim 1 wherein fits in base stand stabilizer core 6 the hawk and pasting tray also can rest within upper extension attachment core hawk 29 or within the top extension arm 8 the hawk and pasting tray can rest within the base stand stabilizer core 6 whereby the upper extension attachment thumb slot 5 will allow the hawk to be easily removed for use and the hawk can be used while within the top extension arm 8 until needed to stand alone with base stand stabilizer 7 A tubular post 35 of claim 1 wherein with a middle annular swale rigid cincture, a tubular spar 35 of claim 1 wherein rests on top the base stand stabilizer 7 whereby and the lumen rests within in combination with an oblate carriage, the removable shaft is tubular of claim 1 wherein rests in a clevis whereby having a removable stanchion with a mortise for easy release. All extensions 3, 14, 22, 23 of claim 1
5. wherein can homologously rest within sleeve, an oblate on top fundus hollowed foramen in the middle with the lumen. The base stand stabilizer 7 of claim 1 wherein may rest by means of anticline of base stabilizer 30 for further stabilization, the base stand stabilizer 7 of claim 1 wherein may also be annular on the horizontal plan whereby further stabilized with aperture, the base stabilizer 30 of claim 1 wherein with verticle plurality of elongated support members of substantially appropriate lengths with aperture, the base stand 2 of claim 1 wherein with verticle plurality of elongated support members of substantially appropriate lengths with aperture, the base stand 2 of claim 1 wherein may have a concave header by means of with acclivity whereby for added stability, the base stabilizer 30 of claim 1 wherein may have a concave header by means of with acclivity whereby for added stability.
Height extension attachment 14 of claim 1 wherein may use the twist lock 19, 20, 24 with the lock slots 26, 27, 28 to lengthen with the extension piece 22, height extension attachment 14 may vary in its mode of attachment as to achieve extension.
6. The paste tray and hawks' arm of claim 1 wherein rests within the top extension 8 by means of the extension attachment 3, 14, 22 can be extended and twist locked 19, 20, 24 whereby due to small slots 26, 27, 28 placed on the top of the extension pieces 3, 14, 22, 23.
7. The extension 3, 14, 22, 23 of claim 1 wherein having the support (?) may be modified for adjustable height by means of the height extension 3, 14 and may not be used if the user does not require height, the height extension 3, 14, can be extended individually whereby as to get the approximate height required.
8. The paste tray base stabilizer 2, 30 of claim 1 wherein can be used alone by means of with the hawk, paste tray top extension 8 and may whereby rest alone within the extension stabilizer core 6 as needed.
9. The said unit of claim 1 wherein may not be limited to the approximate attachment piece extensions 3, 14, 22, 23 being able to extend by
10. other such approximate by means of electrical, hydraulics, pneumatics etc.

1-10. (canceled)

11. support stand of claim 11 wherein to stand upright freely and extend height.

12. The support tray 1 of claim 11 wherein having a base stand 2, 30 has a core which the support tray 1 rests in within the top of the top extension 8 and the top extension 8 fits within the top extension attachment 3 can be extended for with the extension attachment 3, 14, the user can now free up their hands to do another task until ready to use.

13. The extension attachment 3 of claim 12 wherein lock in place with the extra extension 22 for stability. A thumb slot 5 of claim 11 wherein located on the side of the housing stand arm top extension 8 and the extension attachment 3 has a slot 10 for quick release from the top extension 8.

14. Top extension arm 8 of claim 13 wherein fits in base stand stabilizer core 6 or within the top extension arm 8 can rest within the base stand stabilizer core 6 the upper extension attachment thumb slot 5 will allow to be easily removed for use can be used while within the top extension arm 8 until to stand alone with base stand stabilizer 7

15. tubular post 35 of claim 14 wherein with a middle annular swale rigid cincture, a tubular spar 35 of claim 11 wherein rests on top the base stand stabilizer 7 and the lumen rests within in combination with an oblate carriage, the removable shaft is tubular of claim 11 wherein rests in a clevis having a removable stanchion with a mortise for easy release.

16. Extensions 3, 14, 22, 23 of claim 15 wherein can homologously rest within sleeve, an oblate on top fundus hollowed foramen in the middle with the lumen. The base stand stabilizer 7 of claim 1 wherein anticline of base stabilizer 30 for further stabilization, the base stand stabilizer 7 of claim 11 wherein may be annular on the horizontal further stabilized with aperture, the base stabilizer 30 of claim 11 wherein verticle plurality of elongated support members of substantially appropriate lengths with aperture, the base stand 2 of claim 11 wherein with verticle plurality of elongated support members of substantially appropriate lengths with aperture, the base stand 2 of claim 11 wherein concave header with acclivity for added stability, the base stabilizer 30 of claim 11 wherein a concave header with acclivity for stability.

17. Height extension attachment 14 of claim 16 wherein may use the twist lock 19, 20, 24 with the lock slots 26, 27, 28 to lengthen with the extension piece 22, height extension attachment 14 attachment to achieve extension.

18. The arm of claim 17 wherein rests within the top extension 8 the extension attachment 3,14, 22 can be extended and twist locked 19, 20, 24 whereby due to small slots 26, 27, 28 placed on the top of the extension pieces 3, 14, 22, 23.

19. The extension 3, 14, 22, 23 of claim 18 wherein the support tray 1 modified for adjustable height, the height extension 3, 14, the height extension 3, 14, can be extended individually.

20. The base stabilizer 2, 30 of claim 19 wherein can be used alone with the top extension 8 and rest alone within the extension stabilizer core 6.

21. The unit of claim 20 wherein attachment piece extensions 3, 14, 22, 23 being able to extend

22. [symbol]
